(19) United States
(12) Patent Application Publication
(10) Pub. No.: US 2025/0265761 A1
(43) Pub. Date: Aug. 21, 2025

(54) DISPLAY DEVICE PROJECTING LIGHT 360 DEGREES THROUGH TRAINED METASURFACE AND PERFORMING THREE-DIMENSIONAL IMAGING, AND CONTROLLING METHOD THEREOF

(71) Applicant: POSTECH RESEARCH AND BUSINESS DEVELOPMENT FOUNDATION, Pohang-si (KR)

(72) Inventors: Eunsue CHOI, Pohang-si (KR); Gyeongtae KIM, Pohang-si (KR); Junsuk RHO, Pohang-si (KR); Seung-Hwan BAEK, Pohang-si (KR)

(73) Assignee: POSTECH RESEARCH AND BUSINESS DEVELOPMENT FOUNDATION, Pohang-si (KR)

(21) Appl. No.: 18/776,856

(22) Filed: Jul. 18, 2024

(30) Foreign Application Priority Data
Feb. 15, 2024 (KR) 10-2024-0022134
May 22, 2024 (KR) 10-2024-0066575

(51) Int. Cl. G06T 15/00; G06T 7/50; G06V 10/44

(52) U.S. Cl. CPC G06T 15/00; G06T 7/50; G06V 10/44

(57) ABSTRACT

Provided are a display device that projects light 360 degrees and performs three-dimensional (3D) imaging through a trained metasurface, and a controlling method of the display device. The display device includes a light control module including a camera module including a metasurface and a plurality of fisheye cameras, and a processor for controlling the light control module, wherein the processor is configured to model light propagating from the metasurface, render a virtual image when an image of a virtual space into which the propagated light is projected is captured by the camera module, and obtain depth information of the rendered virtual image by using a depth extraction network.

### CROSS-REFERENCE TO RELATED APPLICATIONS

This application is based on and claims priority under 35 U.S.C. § 119 to Korean Patent Application Nos. 10-2024-0022134, filed on Feb. 15, 2024, and 10-2024-0066575, filed on May 22, 2024, in the Korean Intellectual Property Office, the disclosures of which are incorporated by reference herein in their entireties.

### BACKGROUND

### 1. Field

The disclosure relates to a display device that projects light 360 degrees through a trained metasurface and performs three-dimensional imaging, and a controlling method of the display device. Specifically, the disclosure relates to a framework for three-dimensional imaging by projecting structured light 360 degrees using a trained metasurface.

This study was conducted with the support of the Samsung Future Technology Promotion Project.

### 2. Description of the Related Art

Active stereo technology may be a technology that projects light having a specific pattern to the outside and extracts depth information by using a plurality of cameras. A display device to which the existing active stereo technology is applied may include a diffractive optical element (DOE). The diffractive optical element may adjust a phase delay value of incident light according to an incident position of light. The diffractive optical element may have different steps depending on the incident positions. The steps of the diffractive optical element may be formed for each pixel. The size of the pixel of the diffractive optical element may be larger than the wavelength of light. When the angle of light projected into the diffractive optical element increases, the diffraction efficiency may decrease. For example, it may not be easy to extract depth information by using a diffractive optical element when the angle of light projected into the diffractive optical element is 70 degrees or more.

Recently, a metasurface manufactured through a nano process and having a pixel having a size smaller than the wavelength of light has been used. The metasurface may project light forward 180 degrees when using a transmission direction. The metasurface may project light forward and backward 360 degrees when using a transmission direction and a reflection direction. The conventional metasurface used a higher-order diffraction coefficient to project light 180 degrees. When a higher-order diffraction coefficient is used, the projected light pattern may be limited to a dot pattern. Accordingly, it may not be easy for an existing metasurface to efficiently extract depth information from a specific external space.

### SUMMARY

Additional aspects will be set forth in part in the description which follows and, in part, will be apparent from the description, or may be learned by practice of the presented embodiments of the disclosure.

According to an aspect of the disclosure, a display device that projects light 360 degrees and performs three-dimensional (3D) imaging through a trained metasurface, includes a light control module including a camera module including a metasurface and a plurality of fisheye cameras, and a processor for controlling the light control module, wherein the processor is configured to model light propagating from the metasurface, render a virtual image when a virtual space into which the propagated light is projected is captured by the camera module, and obtain depth information of the rendered virtual image by using a depth extraction network.

According to another aspect of the disclosure, a controlling method of a display device that projects light 360 degrees and performs three-dimensional (3D) imaging through a trained metasurface, includes the operations of modeling light propagating from the metasurface, rendering a virtual image when a virtual space into which the propagated light is projected is captured by the camera module, and extracting depth information of the rendered virtual image by using a depth extraction network.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a display device according to an embodiment;

FIG. 2 is a diagram illustrating a framework for implementing a controlling method of a display device, according to an embodiment;

FIG. 3 is a diagram illustrating a metasurface of a display device, according to an embodiment;

FIG. 4 is a diagram illustrating a metasurface of a display device, according to an embodiment;

FIG. 5 is a diagram illustrating a nano structure of a metasurface according to an embodiment;

FIG. 6 is a diagram illustrating a light propagation model of a display device, according to an embodiment;

FIG. 7 is a diagram illustrating a light propagation model of a display device, according to an embodiment;

FIG. 8 is a diagram illustrating fisheye camera rendering in a display device, according to an embodiment;

FIG. 9 is a diagram illustrating fisheye camera rendering in a display device according to an embodiment;

FIG. 10 is a diagram illustrating a depth extraction network of a display device, according to an embodiment;

FIG. 11 is a block diagram illustrating a depth extraction network of a display device, according to an embodiment;

FIG. 12 is a block diagram illustrating a light control module of a display device, according to an embodiment;

FIG. 13A is a diagram illustrating a process of manufacturing a metasurface, according to an embodiment;

FIG. 13B is a diagram illustrating a process of manufacturing a metasurface, according to an embodiment;

FIG. 13C is a diagram illustrating a process of manufacturing a metasurface, according to an embodiment;

FIG. 13D is a diagram illustrating a process of manufacturing a metasurface, according to an embodiment;

FIG. 14 is a diagram illustrating an omnidirectional camera of a display device, according to an embodiment; and

FIG. 15 is a diagram illustrating a metalens of a display device, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The description of the following embodiments should not be construed as limiting the scope of rights, and what those skilled in the art may easily infer should be construed as belonging to the scope of rights of the embodiments. Hereinafter, embodiments solely for illustration will be described in detail with reference to the accompanying drawings.

Hereinafter, embodiments will be described in detail with reference to the accompanying drawings. In the following drawings, the same reference numerals refer to the same components, and the size of each component in the drawings may be exaggerated for clarity and convenience of description. Meanwhile, embodiments described below are merely illustrative, and various modifications are possible from these embodiments.

Hereinafter, the term “upper portion” or “on” may also include “to be present on the top, bottom, left or right portion on a non-contact basis” as well as “to be present just on the top, bottom, left or right portion in directly contact with”. The singular expression may include plural expressions unless the context clearly implies otherwise. In addition, when a part may “include” a component, this may mean that the part may further include other components, not excluding other components unless otherwise opposed.

The use of the term “the” and similar indicative terms may correspond to both singular and plural. If there is no explicit description or contrary description of the order of the steps or operations constituting the method, these steps or operations may be carried out in an appropriate order and are not necessarily limited to the described order.

Further, the terms “unit”, “module” or the like mean a unit that processes at least one function or operation, which may be implemented in hardware or software or implemented in a combination of hardware and software.

The connection or connection members of lines between the components shown in the drawings exemplarily represent functional connection and/or physical or circuit connections, and may be replaceable or represented as various additional functional connections, physical connections, or circuit connections in an actual device.

An expression such as “at least one” that precedes an element list limits the entire element list and does not limit individual elements in the list. For example, expressions such as “at least one of A, B and C” or “at least one selected from the group consisting of A, B, and C” may be interpreted as A only, B only, C only, or a combination of two or more of A, B, and C, such as ABC, AB, BC, and AC.

When “about” or “substantially” is used in connection with a numerical value, the relevant numerical value may be interpreted to include manufacturing or operating variations (e.g., ±10%) around the specified numerical value. Alternatively, when the terms “generally” and “substantially” are used in relation to a geometric shape, it may be intended that a geometric fixed amount is not required, and the tolerance for the shape is within the scope of this embodiment. Alternatively, regardless of whether a numerical value or shape is limited to “about” or “substantially,” these values and shapes may be interpreted as including manufacturing or operating deviations (e.g., ±10%) around the specified numerical value.

The terms first, second, etc. may be used to describe various components, but the components should not be limited by the terms. Terms may be used only for the purpose of distinguishing one component from another.

The use of all examples or illustrative terms is simply to describe technical ideas in detail, and the scope is not limited due to these examples or illustrative terms unless the scope is limited by the claims.

Hereinafter, embodiments solely for illustration will be described in detail with reference to the accompanying drawings.

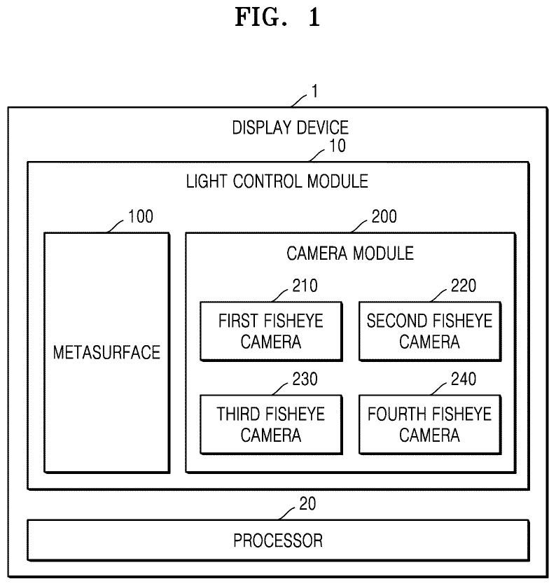

FIG. 1 is a block diagram illustrating a display device 1 according to an embodiment. The display device 1 may project light to the surroundings thereof. The display device 1 may perform three-dimensional (3D) imaging. The display device 1 may recognize the depth of a surrounding scene by using active stereo technology. The active stereo technology may be technology for extracting depth information of a scene by using the parallax of each of a plurality of cameras. The display device 1 may image a scene in three dimensions based on the extracted depth information. The display device 1 according to an embodiment may include a light control module 10 and a processor 20.

The light control module 10 may project light of a specific pattern to the surroundings thereof. The light control module 10 may receive light reflected from the surrounding environment after being projected. The light control module 10 may include a metasurface 100 and a camera module 200.

The metasurface 100 may propagate light having a specific pattern to the surroundings thereof. The metasurface 100 may be manufactured through a nano process. The metasurface 100 may have a pixel size having a wavelength or less. The metasurface 100 may project light forward 180 degrees when using a transmission direction. The metasurface 100 may project light forward and backward 360 degrees when using a transmission direction and a reflection direction. The metasurface 100 may be trained to project light 360 degrees.

The camera module 200 may receive light which is propagated from the metasurface 100 and is reflected from the surrounding environment. The camera module 200 may include a first fisheye camera 210, a second fisheye camera 220, a third fisheye camera 230, and a fourth fisheye camera 240. However, embodiments are not limited thereto, and the camera module 200 may include a plurality of fisheye cameras other than four fisheye cameras. The camera module 200 may receive light through each of the plurality of fisheye cameras 210, 220, 230, and 240.

The processor 20 may model light propagating from the metasurface 100. A pattern of light projected around the metasurface 100 may be modeled.

The processor 20 may render a virtual image when an image of the virtual space on which the propagated light is projected is captured by the camera module 200. The processor 20 may generate a virtual image in which a scene is expressed based on the light received by the light control module 10. The processor 20 may render the virtual image to correspond to the scene.

The processor 20 may obtain depth information of the rendered virtual image by using a depth extraction network. The processor 20 may extract depth information of the virtual image based on the light received by the light control module 10. The processor 20 may extract depth information of the virtual image based on the parallax of light received from each of the plurality of fisheye cameras 210, 220, 230, and 240 of the camera module 200.

The display device 1 according to an embodiment may project light 360 degrees and perform 3D imaging through the trained metasurface 100. Accordingly, the disclosure may provide an end-to-end design framework (E2E design framework) that simultaneously provides hardware and software for performing 360-degree light projection and 3D imaging by using the metasurface 100. The E2E design framework according to an embodiment may integrate and optimize optical elements and image processing algorithms. The E2E design framework according to an embodiment may use the trained metasurface 100. The E2E design framework according to an embodiment may extract depth information for a 360-degree scene and perform 3D imaging by using the trained metasurface 100. The E2E design framework according to the disclosure may be applied to 3D imaging, holographic display, light detection and ranging (LiDAR), virtual reality (VR) display, or augmented reality (AR) display fields.

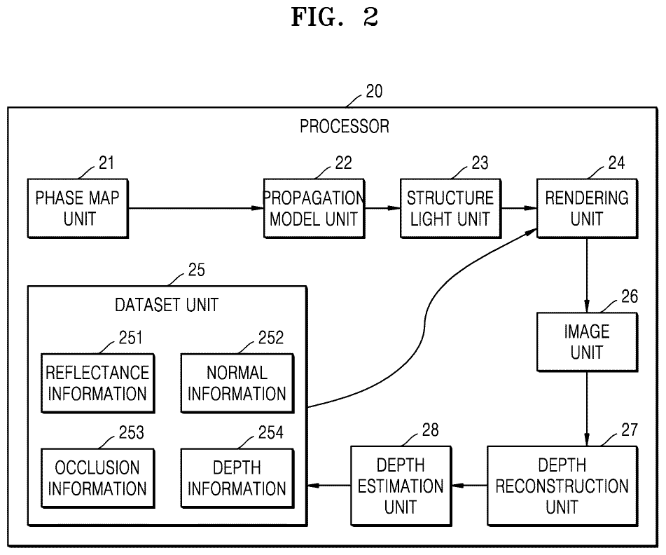

FIG. 2 is a diagram illustrating a processor 20 of a display device 1, according to an embodiment. The processor 20 may perform the overall operation included in the E2E design framework of the display device 1 according to an embodiment. The processor 20 may include a phase map unit 21, a propagation model unit 22, a structured light unit 23, a rendering unit 24, a dataset unit 25, an image unit 26, a depth reconstruction unit 27, and a depth estimation unit 28.

The phase map unit 21 may generate a phase map of the metasurface 100. The phase map of the metasurface 100 may be a map in which the metasurface 100 is divided for each unit region and a phase value of each unit region is displayed. The phase map unit 21 may transmit the phase map of the metasurface 100 to the propagation model unit 22.

The propagation model unit 22 may receive the phase map of the metasurface 100. The propagation model unit 22 may generate a 360-degree propagation model based on the phase map of the metasurface 100. The 360-degree propagation model may include an algorithm for deriving how light is propagated from the metasurface 100. The 360-degree propagation model may model a pattern of light projected from the metasurface 100 to the surrounding scene. The propagation model unit 22 may transmit the generated 360-degree propagation model to the structured light unit 23.

The structured light unit 23 may receive a 360-degree propagation model. The structured light unit 23 may express 360 degrees structured light by using a neural network. The structured light unit 23 may express 360 degrees structured light in a differentiable image formation method. The structured light unit 23 may transmit the result of expressing the 360-degree structured light to the rendering unit 24.

The rendering unit 24 may receive a result of expressing 360-degree structured light. The rendering unit 24 may receive a dataset related to a virtual space in which a surrounding scene is photographed by using the camera module 200. The rendering unit 24 may perform fisheye camera rendering based on the result of representing the 360-degree structured light and the dataset. The rendering unit 24 may transmit a result of performing fisheye camera rendering to the image unit 26.

The dataset unit 25 may receive, from the camera module 200, a virtual space in which a surrounding scene is photographed. The dataset unit 25 may generate a dataset related to the virtual space based on the received virtual space and the received depth information of the virtual space. The dataset generated by the dataset unit 25 may include reflection information 251, normal information 252, occlusion information 253, and depth information 254. The dataset unit 25 may transmit the generated dataset to the rendering unit 24.

The image unit 26 may receive a result of performing fisheye camera rendering. The image unit 26 may generate a rendered virtual image based on a result of performing fisheye camera rendering. The image unit 26 may transmit the rendered virtual image to the depth reconstruction unit 27.

The depth reconstruction unit 27 may receive the rendered virtual image. The depth reconstruction unit 27 may reconstruct the depth of the rendered virtual image based on the rendered virtual image. The depth reconstruction unit 27 may transmit the depth of the reconstructed virtual image to the depth estimation unit 28.

The depth estimation unit 28 may receive the depth of the reconstructed image. The depth estimation unit 28 may obtain depth information of the virtual space based on the depth of the reconstructed image. The depth estimation unit 28 may transmit depth information of the virtual space to the dataset unit 25.

The processor 20 according to an embodiment may model back-propagation in a gradient descent algorithm-based manner. The gradient descent algorithm may be an optimization algorithm for finding a primary approximation. The gradient descent algorithm may include a method of calculating the gradient of a function, continuing to move the approximation in a direction opposite to the gradient of the function, and repeating the operation until the approximation reaches a pole value. The processor 20 according to an embodiment may implement a neural network-based depth estimation model. The processor 20 estimates depth information of each of the rendered images from each of the plurality of cameras. The processor 20 may calculate a loss value by substituting the estimated depth information and ground-truth data into a loss function. The processor 20 may calculate a gradient of the calculated loss value. The processor 20 may provide an E2E design framework that simultaneously optimizes a phase change value and a depth estimation network by back-propagating the gradient of the loss value.

The processor 20 according to an embodiment may perform the operation of the E2E design framework to optimize the phase map of the metasurface 100 and the parameters of the depth reconstruction neural network through a combination of the phase map of the metasurface 100 and the parameters of the depth reconstruction neural network. Accordingly, the processor 20 according to an embodiment may generate 360-degree structured light optimized to be suitable for a 3D image.

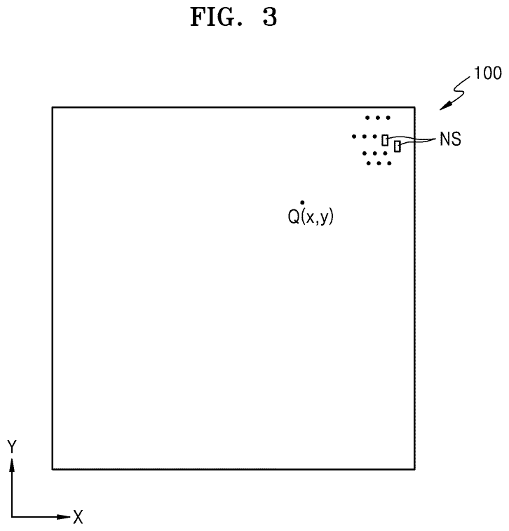

FIG. 3 is a diagram illustrating a metasurface 100 of a display device 1 according to an embodiment.

The metasurface 100 may include a nano structure NS. The nano structure NS may convert phases and patterns of light propagated by the metasurface 100. The nano structure NS may diffract light propagated by the metasurface 100. The nano structure NS may be arranged at a first position Q(x,y). The nano structure NS arranged at the first position Q(x,y) may change the phase and pattern of light propagated at the first position Q(x,y).

The nano structure NS may include a material having a refractive index different from that of the surrounding material. For example, the nano structure NS may include a material having a higher refractive index than the surrounding material. For example, the nano structure NS may include c-Si, p-Si, a-Si, and group III-V compound semiconductors (e.g., GaP, GaN, GaAs, etc.), SiC, TiO₂, SiN, and/or a combination thereof. The nano structure NS may include a resin material and a nano composite including nanoparticles dispersed in the resin material. The resin material may be a UV curable resin. Nanoparticles may be Si or TiO₂ nanoparticles. A high refractive atomic layer 135 may be formed on the surface of the nano structure NS.

The material around the nano structure NS may include a material having a refractive index different from that of the nano structure NS. For example, the material around the nano structure NS may include a dielectric material having a lower refractive index than the nano structure NS. For example, the material around the nano structure NS may include SiO₂ or air.

The metasurface 100 may form structured light having an arbitrary pattern. For example, the metasurface 100 may form structured light having a regular or irregular dot pattern.

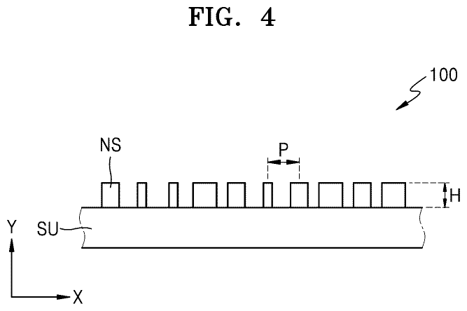

FIG. 4 is a diagram illustrating a metasurface 100 of a display device 1 according to an embodiment.

The nano structure NS may be arranged on a support layer SU. The support layer SU may include any one of glass (e.g., fused silica, or BK7), quartz, polymer (e.g., PMMA, or SU-8), and plastic. The support layer SU may be a semiconductor substrate. The support layer SU may have a refractive index different from that of the nano structure NS. The support layer SU may include a material having a lower refractive index than the nano structure NS.

The arrangement pitch P of the nano structures NS may be a distance between adjacent nano structures NS. The arrangement pitch P of the nano structures NS may be set to be equal to or less than half wavelength of light propagated by the metasurface 100.

The nano structure NS may have a set rotation angle. The nano structure NS may delay the phase of light incident on the metasurface 100 by twice the rotation angle. Light incident on the metasurface 100 may have a circular polarization state such as Right Circularly Polarized (RCP) or Left Circularly Polarized (LCP). The nano structure NS may be designed to convert a rotation direction of circularly polarized light incident on the metasurface 100. The metasurface 100 may form structured light with a wide viewing angle by using the nano structure NS. For example, the metasurface 100 may form structured light having a viewing angle of 180 degrees or less.

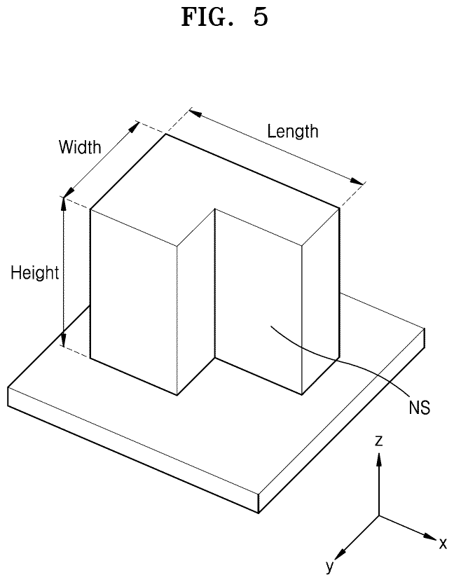

FIG. 5 is a diagram illustrating a nano structure NS of a metasurface 100 according to an embodiment.

The nano structure NS may have a rectangular parallelepiped shape having a specified length, width, and height. The phase control efficiency of the nano structure NS may be set according to a length, a width, and a height.

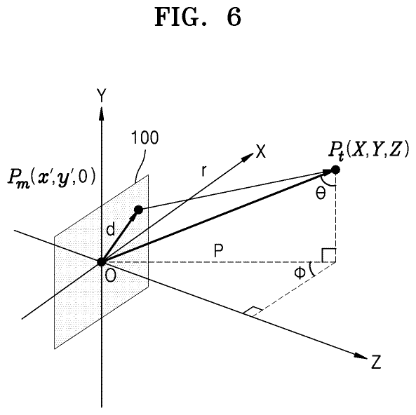

FIG. 6 is a diagram illustrating a light propagation model of a display device 1 according to an embodiment.

The display device 1 may project light 360 degrees through the trained metasurface and perform 3D imaging. The display device 1 may include a light control module 10 and a processor 20 for controlling the light control module 10. The processor 20 of the display device 1 may include a light propagation model.

The light propagation model may model light propagating from the metasurface 100. The light propagation model may model light propagated by a phase delay on the metasurface 100. The light propagation model may model light propagating from the metasurface 100 180 degrees. The light propagation model may model light propagating from the metasurface 100 computationally efficiently.

The light propagation model may model light propagating from the metasurface 100 from a plane to a sphere without performing paraxial approximation. Existing models were able to model the propagating light only for a narrow angular range by performing paraxial approximation. The light propagation model may model propagating light to 180 degrees computationally efficiently in the following manner.

Equation 1 may be calculated by representing the Rayleigh-Sommerfeld diffraction integration equation in spherical coordinates.

$$U ( ρ , θ , ϕ ) = \frac{1}{λ j} \int \int {U}^{′} ( {x}^{′} , {y}^{′} ) \frac{{e}^{jkr}}{r} ( 1 - \frac{1}{jkr} ) \frac{ρ sin θ sin ϕ}{r} {dx}^{′} {dy}^{′} \qquad [ Equation 1 ]$$

U′ may be the waveform of a source of a light propagation model. The source may be located at a source point Pₘ. U may be the waveform of a target to be modeled by the light propagation model. The target may be located at a target point Pₜ. It is not easy to model light propagating to the target point Pₜ using Equation 1. The light propagation model may use Equation 2 obtained by converting Equation 1.

$$U ( ρ , θ , ϕ ) = τ \int \int {U}^{′} ( {x}^{′} , {y}^{′} ) {e}^{- 2 π j ( \frac{s i n θ c os ϕ}{λ} {x}^{′} + \frac{c os θ}{λ} {y}^{′} )} {dx}^{′} {dy}^{′} \qquad [ Equation 2 ]$$

Equation 2 may be expressed as a Fourier transform to easily model light propagating to the target point Pₜ. The T generated in Equation 2 may be expressed as Equation 3.

$$τ = \frac{{e}^{jk ρ}}{λ j} \frac{sin θ sin ϕ}{ρ} \qquad [ Equation 3 ]$$

The τ may model a phenomenon in which the intensity of the propagated light decreases as the diffraction angle of the propagated light increases. The τ may model a phenomenon in which the intensity of the propagated light decreases as the distance of the propagated light increases.

The light propagation model may obtain Equation 4 by performing Fourier transform of Equation 2 and then performing reparameterization.

$$U = τ ⊙ {f}_{reparam} ( F \{ {U}^{′} \} ) \qquad [ Equation 4 ]$$

The light propagation model may computationally efficiently calculate the waveform of the target from the waveform of the source by using Equation 4. The light propagation model may model the waveform of light propagating to the target point Pₜ 180 degrees.

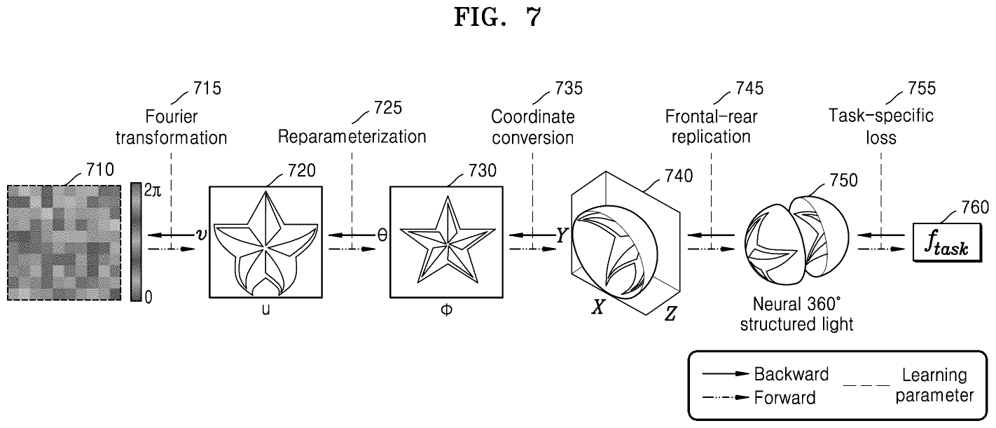

FIG. 7 is a diagram illustrating a light propagation model of a display device 1 according to an embodiment. The processor 20 of the display device 1 may execute a light propagation model.

The processor 20 may model light propagation with respect to a phase map 710 of a metasurface 100. The processor 20 may apply Fourier transformation 715 to the phase map 710. The processor 20 may obtain first intermediate data 720 by applying Fourier transformation 715 to the phase map 710.

The processor 20 may perform reparameterization 725 on the first intermediate data 720. The processor 20 may reparameterize the first intermediate data 720 to obtain the second intermediate data 730.

The processor 20 may apply coordinate conversion 735 in which light propagates 180 degrees for modeling. The processor 20 may convert planar coordinates into spherical coordinates for coordinate conversion. The processor 20 may obtain the third intermediate data 740 by performing coordinate conversion 735 on the second intermediate data 730.

After applying the coordinate conversion, the processor 20 may model a form in which light propagates 360 degrees by performing frontal-rear replication 745. The processor 20 may obtain structured light 750 by performing the frontal-rear replication 745 on the third intermediate data 740. The structured light 750 may be a result of modeling light propagating at 360 degrees.

The processor 20 may perform a task-specific loss 755 on the structured light 750 to generate a final result function 760. The processor 20 may model light that is computationally efficiently propagated by using the light propagation model.

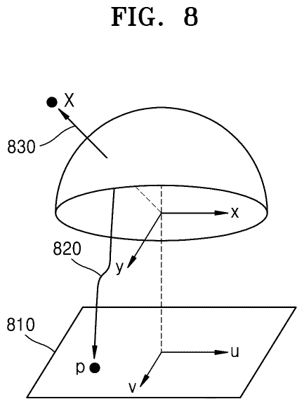

FIG. 8 is a diagram illustrating fisheye camera rendering of a display device 1 according to an embodiment. The processor 20 of the display device 1 may process propagated light being projected onto a virtual space. The camera module 200 of the display device 1 may obtain a virtual image by photographing the virtual space. The processor 20 may render a virtual image when the virtual space is photographed by the camera module 200.

The virtual image may be an image visible from the perspective of the camera module 200 when light propagated from the metasurface 100 is reflected from the surroundings and returns to the camera module 200. The processor 20 may assume a virtual space in which a light pattern is projected after calculating where and at what intensity the light passing through the metasurface 100 is propagated using the light propagation model. The processor 20 may render the virtual image when the virtual space is photographed by the camera module 200.

The camera module 200 may include a plurality of fisheye cameras. A virtual image captured by a fisheye camera may be distorted compared to a virtual image captured by a perspective camera. The processor 20 may render the virtual image to compensate for distortion of the virtual image captured by the fisheye camera.

The processor 20 may perform a projection 820 at a point p on a camera image plane 810. The processor 20 may perform an inverse projection 830 of projecting the result of the projection 820 onto the spherical coordinates which converts a vector X inversely. The processor 20 may compensate for distortion of the virtual image by performing unprojection 830.

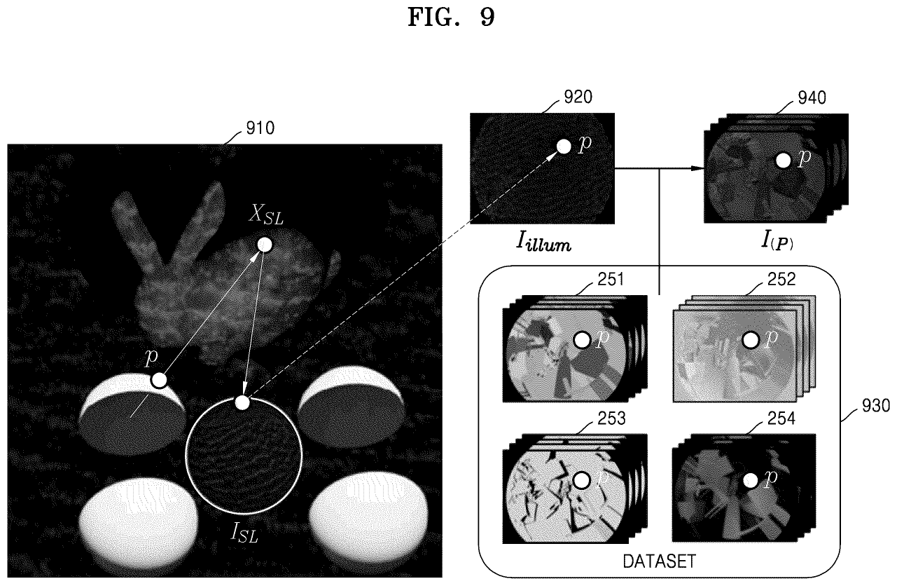

FIG. 9 is a diagram illustrating fisheye camera rendering of a display device 1 according to an embodiment. The processor 20 of the display device 1 may perform fisheye camera rendering at 360 degrees.

The processor 20 may generate a dataset 930 obtained by photographing a virtual space with a plurality of fisheye cameras. The dataset may include reflection information 251, normal information 252, occlusion information 253, and depth information 254. The processor 20 may obtain the virtual image 910 using the plurality of fisheye cameras included in the camera module 200. The processor 20 may generate a dataset 930 including a first point 920 in the virtual image 910. The processor 20 may generate the dataset 930 for the virtual image 910 in advance. For example, the processor 20 may generate the dataset 930 using an open source rendering tool.

The processor 20 may calculate position information corresponding to the dataset 930 based on the ground truth data. The processor 20 may calculate information related to the first point 920 of the virtual image 910 by performing modeling to correspond to distortion and accurate depth data. The processor 20 may inversely calculate the coordinates of the spatial point projected on each pixel of the virtual image by using the fisheye camera model and the ground truth data considering distortion.

The processor 20 may render pixels of the virtual image 910 based on the position information. The processor 20 may render the pixels by substituting the position information and the dataset 930 into a rendering equation. The processor 20 may substitute a form in which a light pattern propagates at the first point 920 and pixel information at the first point 920 into a rendering equation. The rendering equation may be expressed as Equation 5.

$$I ( p ) = {f}_{clip} ( S ( p ) ⊙ R ( p ) ⊙ ( O ( p ) ⊙ + {I}_{illum} + β ) + η ) \qquad [ Equation 5 ]$$

In Equation 5, Iᵢₗₗᵤₘ may represent the intensity of the light pattern propagated to the coordinates of the first point 920. In Equation 5, p may represent pixel position information at the first point 920. In Equation 5, β may represent ambient light. In Equation 5, n may represent noise caused by the camera module 200. In Equation 5, f_{clip} may represent an intensity storage model of the camera module 200. The processor 20 may obtain a rendering image 940 at the first point 920 in response to the rendering equation.

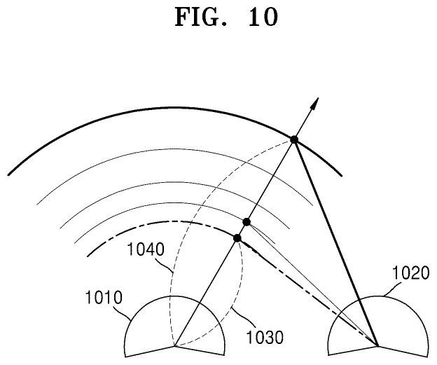

FIG. 10 is a diagram illustrating a depth extraction network of a display device 1 according to an embodiment. The processor 20 of the display device 1 may obtain depth information of the rendered virtual image by using a depth extraction network. The processor 20 may input the rendered virtual image to the depth reconstruction unit. The processor 20 may extract depth information of the virtual image by processing the rendered virtual image using the depth reconstruction unit.

The processor 20 may obtain information related to a photographing distance and a photographing angle of each of a reference camera 1010 and a target camera 1020. The processor 20 may obtain a minimum depth 1030 and a maximum depth 1040 with respect to the reference camera 1010. The processor 20 may obtain parallax information between the reference camera 1010 and the target camera 1020 between the minimum depth 1030 and the maximum depth 1040. The processor 20 may obtain depth information based on parallax information between the reference camera 1010 and the target camera 1020.

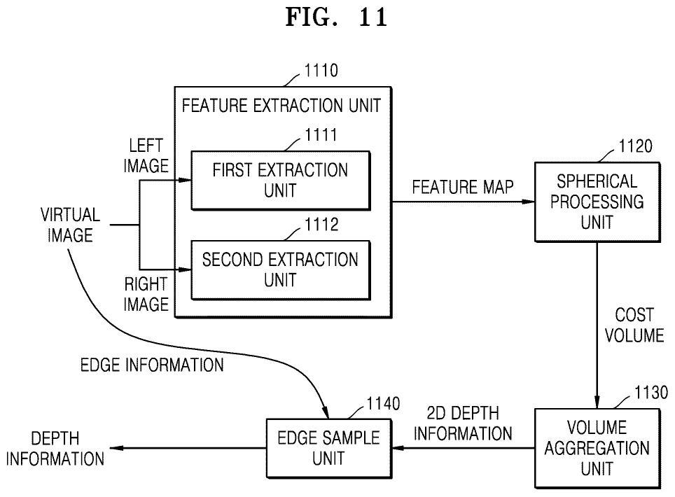

FIG. 11 is a diagram illustrating a depth extraction network of a display device 1 according to an embodiment. The processor 20 of the display device 1 may input the rendered virtual image to the depth extraction network. The processor 20 may derive depth information of a rendered virtual image through a series of processing processes using the depth extraction network.

The processor 20 may extract a feature point from the virtual image. The processor 20 may divide the virtual image into a left image and a right image. The processor 20 may input the left image and the right image to a feature extraction unit 1110. The processor 20 may input the left image to a first extraction unit 1111. The processor 20 may input the right image to a second extraction unit 1112. The processor 20 may obtain a feature map of the virtual image using the feature extraction unit 1110. The processor 20 may extract a low-resolution feature point from a captured image by using a convolutional neural network (CNN). The processor 20 may use more and more significant information by using the convolutional neural network than when only the image captured in a stereo-based depth estimation method is used. The processor 20 may increase depth estimation accuracy by using a method of extracting feature points.

The processor 20 may find a matching point of the feature points by using a spherical volume production method. The processor 20 may input the feature map to a spherical processing unit 1120. The processor 20 may find a matching point of the feature map extracted from the plurality of fisheye cameras by using spherical sweeping having a principle similar to that of plane sweeping used in depth estimation using a perspective camera.

The processor 20 may obtain a cost volume of the virtual image based on the matching point. The processor 20 may obtain a cost volume by finding a matching point by using the spherical processing unit 1120.

The processor 20 may obtain depth information based on the cost volume. The processor 20 may convert the cost volume into two-dimensional (2D) depth information. The processor 20 may input the cost volume to a volume aggregation unit 1130. The processor 20 may convert the cost volume into 2D depth information by using the volume aggregation unit 1130.

The processor 20 may obtain depth information based on edge information and 2D depth information of the virtual image. The processor 20 may input the 2D depth information to an edge sample unit 1140. The processor 20 may input edge information of the virtual image to the edge sample unit 1140. The processor 20 may obtain depth information of the rendered virtual image by using the edge sample unit 1140.

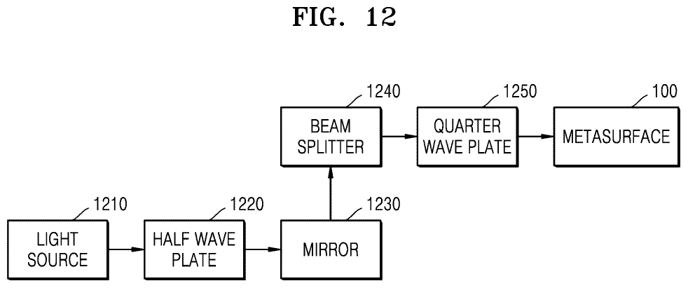

FIG. 12 is a block diagram illustrating a light control module 10 of a display device 1 according to an embodiment. The light control module 10 of the display device 1 according to an embodiment may include a light source 1210, a half wave plate (HWP) 1220, a mirror 1230, a beam splitter 1240, a quarter wave plate (QWP) 1250, and a metasurface 100. The light control module 10 of the display device 1 according to an embodiment may provide a device structure for specifically implementing an E2E design framework according to the disclosure.

The light source 1210 may emit light. The light source 1210 may emit light toward the half wave plate 1220. The light source 1210 may emit linearly polarized light. The light source 1210 may be a laser that emits light of a specific wavelength.

The half wave plate 1220 may control a polarization angle of light emitted from the light source 1210. The half wave plate 1220 may adjust a polarization angle of linearly polarized light. The half wave plate 1220 may transmit, to the mirror 1230, light obtained by adjusting the polarization angle.

The mirror 1230 may reflect light to the beam splitter 1240.

The beam splitter 1240 may reflect or transmit light based on the polarization angle of the light. The beam splitter 1240 may be a polarized beam splitter (PBS). The polarization beam splitter may selectively reflect or transmit light according to the polarization angle of the linearly polarized light. For example, the polarized beam splitter may reflect light that is linearly polarized at −45 degrees. For example, the polarized beam splitter may transmit light that is linearly polarized at +45 degrees. The beam splitter 1240 may transmit selectively reflected light to the quarter wave plate 1250.

The quarter wave plate 1250 may convert a polarization characteristic of light from linear polarization to circular polarization and transmit the same to the metasurface 100. The quarter wave plate 1250 may be a polarizing element that converts linearly polarized light into circularly polarized light.

Left circularly polarized (LCP) light by the quarter wave plate 1250 may be modulated into right circularly polarized (RCP) light on the metasurface 100. The right circularly polarized light reflected from the metasurface 100 may be reflected to the quarter wave plate 1250. The light reflected by the quarter wave plate 1250 may be transmitted in an order opposite to the order described so far. Accordingly, the light control module 10 of the display device 1 according to an embodiment may propagate the light of the light source 1210 360 degrees.

When 3D imaging is performed by using the light control module 10 of the display device 1 according to the disclosure, it may be indicated that various real world objects are included in two different 360-degree landscapes. When 3D imaging is performed by using the light control module 10 of the display device 1 according to the disclosure, depth maps for the front and rear surfaces may be efficiently measured.

The display device 1 according to the disclosure has a low error value as shown in Table 1, and thus may have the effect of more accurately obtaining depth information of a virtual image.

TABLE 1

| | Reciprocal | Reciprocal of | | |
|---|---|---|---|---|
| | of mean | root mean | | Root mean |
| | value of | square value | Mean value | square value |
| | absolute | of absolute | of absolute | of absolute |
| Method | error value | error value | error value | error value |
| Embodiment | 0.072 | 0.202 | 0.237 | 0.547 |
| Comparative | 0.121 | 0.273 | 0.421 | 1.021 |
| example | | | | |
| excluding | | | | |
| metasurface | | | | |
| Random | 0.116 | 0.261 | 0.403 | 0.717 |
| pattern | | | | |
| comparison | | | | |
| example | | | | |
| Dot pattern | 0.149 | 0.321 | 0.492 | 0.859 |
| comparison | | | | |
| example | | | | |

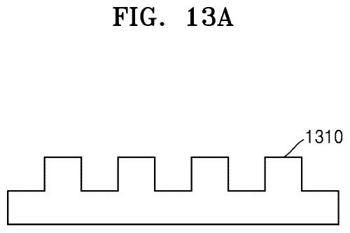

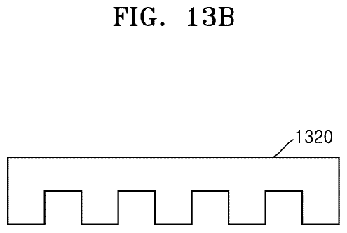

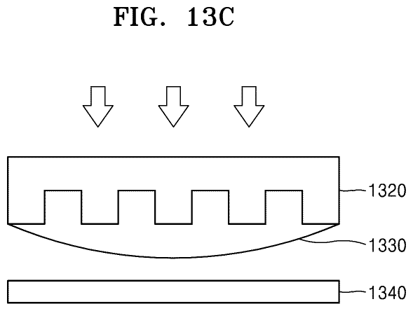

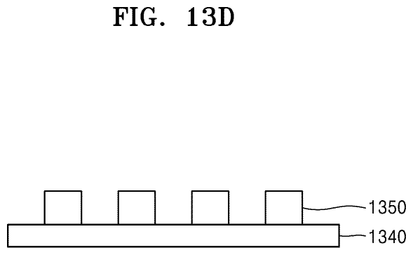

FIG. 13A is a diagram illustrating a process of manufacturing a metasurface 100 according to an embodiment. FIG. 13B is a diagram illustrating a process of manufacturing a metasurface 100 according to an embodiment. FIG. 13C is a diagram illustrating a process of manufacturing a metasurface 100 according to an embodiment. FIG. 13D is a diagram illustrating a process of manufacturing a metasurface 100 according to an embodiment.

In order to manufacture the metasurface 100 according to an embodiment, first, a master mold 1310 may be prepared as shown in FIG. 13A. The master mold 1310 may have a surface having the same shape as the metasurface 100 to be manufactured.

In order to manufacture the metasurface 100 according to an embodiment, a soft mold 1320 may be replicated in reverse image as shown in FIG. 13B. The soft mold may include at least one of polydimethylsiloxane (PDMS) and h-PDMS. A surface of the soft mold 1320 may have a shape opposite to that of the master mold 1310.

In order to manufacture the metasurface 100 according to an embodiment, a curable adhesive 1330 may be applied to the soft mold 1320 and compressed on a substrate 1340 as shown in FIG. 13C. The curable adhesive 1330 may be a curable resin. The curable adhesive 1330 may be cured when irradiated with ultraviolet rays (UV). When the curable adhesive 1330 is applied to the soft mold 1320 and compressed on the substrate 1340, the curable adhesive 1330 may be compressed on the substrate 1340 in the same form as the master mold 1310.

In order to manufacture the metasurface 100 according to an embodiment, it may be manufactured by curing the curable adhesive 1330 compressed on the substrate 1340 as shown in FIG. 13D. When the curable adhesive 1330 compressed on the substrate 1340 is cured, the metasurface 100 in which the cured adhesive 1350 is formed in the same shape as the master mold 1310 may be manufactured. The cured adhesive 1350 may include at least one of ZrO₂ nanoparticles (NPs), TiO₂ nanoparticles, or Si nanoparticles mixed in the resin to increase the refractive index of the metasurface 100. The type of nanoparticles included in the cured adhesive 1350 may be selected according to the wavelength of light propagating from the metasurface 100. For example, when ultraviolet rays are propagated from the metasurface 100, the cured adhesive 1350 may include ZrO₂ nanoparticles. For example, when propagating visible light from the metasurface 100, the cured adhesive 1350 may include TiO₂ nanoparticles. For example, when infrared rays are propagated from the metasurface 100, the cured adhesive 1350 may include Si nanoparticles.

When manufacturing the metasurface 100 according to an embodiment, a high refractive material may be coated on the cured adhesive 1350 to a thickness of 10 nm to 100 nm by applying atomic layer deposition (ALD) to increase the refractive index of the cured adhesive 1350.

When manufacturing the metasurface 100 according to an embodiment, mass production processes such as print lithography and deep ultraviolet (DUV) photolithography may be applied, thereby reducing the manufacturing cost of the metasurface 100. Additionally, at least one of ZrO₂ nanoparticles, TiO₂ nanoparticles, or Si nanoparticles may be used to propagate light in various wavelength bands when manufacturing the metasurface 100 according to an embodiment.

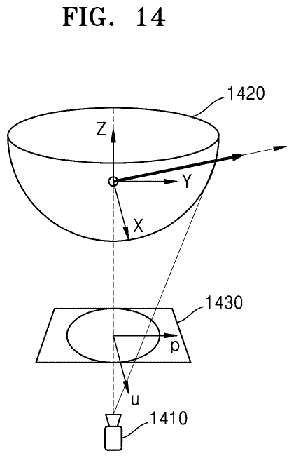

FIG. 14 is a diagram illustrating an omnidirectional camera of a display device 1 according to an embodiment.

The camera module 200 of the display device 1 according to the disclosure may include two omnidirectional cameras 1410 that photograph 360 degrees instead of four fisheye cameras as described with reference to FIG. 1. The omnidirectional camera 1410 may generate a dataset 1420 at 360 degrees.

When two omnidirectional cameras 1410 are used instead of four fisheye cameras, the total number of cameras used is reduced, so that the total volume of the display device 1 may be reduced.

The E2E design framework of the display device 1 according to the disclosure may use an intrinsic parameter of the camera module 200. Accordingly, the omnidirectional camera 1410 may generate the dataset 1420 in the same manner as the method of using fisheye cameras. Accordingly, the E2E design framework of the display device 1 according to the disclosure may project light 360 degrees and perform 3D imaging by using the dataset 1420 generated by the omnidirectional camera 1410.

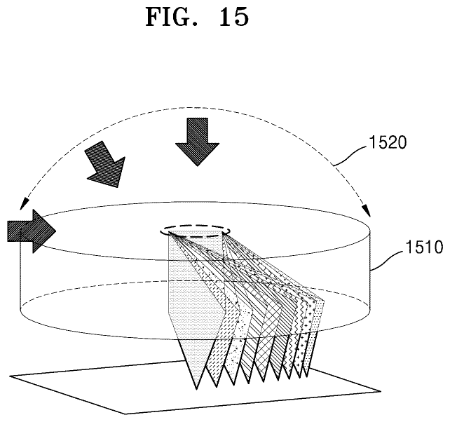

FIG. 15 is a diagram illustrating a meta lens 1510 of a display device 1, according to an embodiment. The meta lens 1510 may separate and propagate light at various angles according to the angle 1520 of the incident light. The meta lens 1510 may be a flat lens. The meta lens 1510 may be a wide-angle lens.

The camera module 200 of the display device 1 according to an embodiment may include a meta lens 1510, which is a metasurface 100-based lens, instead of four fisheye cameras as described with reference to FIG. 1. The display device 1 according to an embodiment may reduce the overall volume of the display device 1 by applying the metalens 1510.

The disclosure is to provide a display device and a control method thereof, which includes an E2E design framework that simultaneously designs hardware and software so that light is projected at a time using a 360-degree metasurface, and the projected light pattern may increase the accuracy of depth information extraction.

The display device that projects light 360 degrees and performs three-dimensional (3D) imaging through a trained metasurface, according to an embodiment, includes a light control module including a camera module including a met surface and a plurality of fisheye cameras, and a processor for controlling the light control module, wherein the processor is configured to model light propagating from the metasurface, render a virtual image when a virtual space into which the propagated light is projected is captured by the camera module, and obtain depth information of the rendered virtual image by using a depth extraction network.

The processor according to an embodiment may model a form in which the light propagates 360 degrees by applying coordinate conversion in which the light propagates 180 degrees for the modeling and performing frontal-rear replication after applying the coordinate conversion.

The processor according to an embodiment may convert planar coordinates into spherical coordinates for the coordinate conversion.

The processor according to an embodiment may generate a dataset obtained by photographing the virtual space with the plurality of fisheye cameras, calculate position information corresponding to the dataset based on ground truth data, and render a pixel of the virtual image based on the position information.

The processor according to an embodiment may render the pixel by substituting the position information and the dataset into a rendering equation.

The processor according to an embodiment may extract a feature point from the virtual image, find a matching point of the feature point by using a spherical volume production method, obtain a cost volume of the virtual image based on the matching point, and obtain the depth information based on the cost volume.

The processor according to an embodiment may convert the cost volume into 2D depth information and obtain the depth information based on the edge information and the 2D depth information of the virtual image.

The light control module according to an embodiment may include a light source emitting light, a half wave plate that controls the polarization angle of the light emitted from the light source, a beam splitter that reflects or transmits the light based on the polarization angle, and a quarter wave plate that converts the polarization characteristics of the light from linear polarization to circular polarization and transmits the circular polarization to the metasurface.

The metasurface according to an embodiment may be manufactured by reverse-image replication of a soft mold, applying a curable adhesive to the soft mold, pressing the curable adhesive on a substrate, and curing the curable adhesive compressed on the substrate.

The camera module according to an embodiment may include an omnidirectional camera or a meta lens.

The controlling method of a display device that projects light 360 degrees and performs three-dimensional (3D) imaging through a trained metasurface, according to an embodiment, includes the operations of modeling light propagating from the metasurface, rendering a virtual image when a virtual space into which the propagated light is projected is captured by the camera module, and extracting depth information of the rendered virtual image by using a depth extraction network.

The modeling of the light according to an embodiment may include: applying coordinate conversion in which the light propagates 180 degrees for the modeling; and performing frontal-rear replication after applying the coordinate conversion to model the form in which the light propagates 360 degrees.

The applying of coordinate conversion in which the light propagates 180 degrees for the modeling according to an embodiment may include converting planar coordinates into spherical coordinates for the coordinate conversion.

The rendering of the virtual image according to an embodiment may include: generating a dataset in which the virtual space is photographed with the plurality of fisheye cameras; calculating position information corresponding to the dataset based on ground truth data; and rendering pixels of the virtual image based on the position information.

The rendering of the pixel according to an embodiment may include rendering the pixel by substituting the position information and the dataset into a rendering equation.

The obtaining of the depth information according to an embodiment may include: extracting a feature point from the virtual image; finding a matching point of the feature point by using a spherical volume production method; obtaining a cost volume of the virtual image based on the matching point; and obtaining the depth information based on the cost volume.

The obtaining of the depth information based on the cost volume according to an embodiment may include: converting the cost volume into 2D depth information; and obtaining the depth information based on the edge information and the 2D depth information of the virtual image.

Prior to the modeling of light propagating from the metasurface according to an embodiment, the controlling method may include: emitting the light; controlling a polarization angle of the emitted light; reflecting or transmitting the light based on the polarization angle; and converting a polarization characteristic of the light from linear polarization to circular polarization and transmitting the same to the metasurface.

The metasurface according to an embodiment may be manufactured by reverse-image replication of a soft mold, applying a curable adhesive to the soft mold, pressing the curable adhesive on a substrate, and curing the curable adhesive compressed on the substrate.

The rendering of the virtual image when captured by the camera module according to an embodiment may include: photographing the virtual space by using an omnidirectional camera or a meta lens; and rendering the virtual image.

The display device and the controlling method thereof according to the disclosure may project light at a time using a metasurface at 360 degrees, and the projected light pattern may increase the accuracy of depth information extraction.

The method according to an embodiment may be implemented in the form of program instructions that may be executed through various computer means and recorded on a computer-readable medium. The computer-readable medium may include program instructions, data files, data structures, and the like, alone or in combination. Program instructions recorded on a medium may be designed and configured specifically for the disclosure or may be known and used by those skilled in a computer software. Examples of computer-readable recording media include magnetic media such as hard disks, floppy disks and magnetic tapes, optical media such as CD-ROMs and DVDs, magneto-optical media such as floptical disks, and hardware devices specifically configured to store and execute program instructions such as ROMs, RAMs, flash memories, etc. Examples of program instructions include machine language codes such as those created by a compiler, as well as advanced language codes that may be executed by a computer using an interpreter or the like.

Some embodiments of the disclosure may also be implemented in the form of a recording medium including instructions executable by a computer, such as a program module executed by a computer. Computer-readable media may be any available media that may be accessed by a computer, and include both volatile and nonvolatile media, and both detachable and non-detachable media. In addition, a computer-readable medium may include both a computer storage medium and a communication medium. Computer storage media include both volatile and nonvolatile, and both detachable and non-detachable media implemented by any method or technology for storing information, such as computer-readable instructions, data structures, program modules, or other data. Communication media typically includes computer readable instructions, data structures, program modules, or other data in a modulated data signal such as a carrier wave, or other transmission mechanism, and includes any information delivery medium. In addition, some embodiments of the disclosure may also be implemented as computer programs or computer program products containing computer-executable instructions, such as computer programs executed by computers.

The device-readable storage medium may be provided in the form of a non-transitory storage medium. Here, a “non-transitory storage medium” only means that it is a device that is tangible and does not include a signal (e.g., electromagnetic waves), and this term does not distinguish between the case where data is stored semi-permanently in the storage medium and the case where data is stored temporarily. For example, the “non-transitory storage medium” may include a buffer in which data is temporarily stored.

According to an embodiment, a method according to various embodiments disclosed in the present document may be included in a computer program product and provided. Computer program products may be traded between sellers and buyers as products. A computer program product may be distributed in the form of a device-readable storage medium (e.g., compact disc read only memory (CD-ROM), or may be distributed directly or online (e.g., downloaded or uploaded) through an application store or between two user devices (e.g., smartphones). In the case of online distribution, at least part of a computer program product (e.g., a downloadable app) may be temporarily stored or created on a device-readable storage medium, such as a manufacturer's server, an application store's server, or a relay server's memory.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A display device that projects light 360 degrees and performs three-dimensional (3D) imaging through a trained metasurface, the display device comprising:
a light control module including a camera module including a metasurface and a plurality of fisheye cameras; and
a processor for controlling the light control module, wherein
the processor is configured to:
model light propagating from the metasurface;
render a virtual image when an image of a virtual space into which the propagated light is projected is captured by the camera module; and
obtain depth information of the rendered virtual image by using a depth extraction network.

2. The display device of claim 1, wherein the processor is configured to:
for the modeling, apply a coordinate conversion in which the light propagates 180 degrees; and
model the form in which the light propagates 360 degrees by performing frontal-rear replication after applying the coordinate conversion.

3. The display device of claim 2, wherein the processor is configured to convert planar coordinates into spherical coordinates for the coordinate conversion.

4. The display device of claim 1, wherein the processor is configured to:
generate a dataset of the virtual space image-captured by the plurality of fisheye cameras;
calculate position information corresponding to the dataset based on ground truth data; and
render pixels of the virtual image based on the position information.

5. The display device of claim 4, wherein the processor is configured to render the pixels by substituting the position information and the dataset into a rendering formula.

6. The display device of claim 1, wherein the processor is configured to:
extract feature points from the virtual image;
find a matching point of the feature points using a spherical volume production method;
obtain a cost volume of the virtual image based on the matching point; and
obtain depth information based on the cost volume.

7. The display device of claim 6, wherein the processor is configured to:
convert the cost volume into two-dimensional depth information; and
obtain the depth information based on edge information of the virtual image and the two-dimensional depth information.

8. The display device of claim 1, wherein the light control module comprises:
a light source emitting the light;
a half-wave plate that controls a polarization angle of the light emitted from the light source;
a beam splitter that reflects or transmits the light based on the polarization angle; and
a quarter-wave plate that converts the polarization characteristics of the light from linear polarization to circular polarization and transmits the circular polarization to the metasurface.

9. The display device of claim 1, wherein the metasurface is manufactured by:
replicating a soft mold in reverse;
applying a curable adhesive to the soft mold and pressing the curable adhesive to the substrate; and
curing the curable adhesive pressed to the substrate.

10. The display device of claim 1, wherein the camera module comprises an omnidirectional camera or a metalens.

11. A controlling method of a display device that projects light 360 degrees and performs three-dimensional (3D) imaging through a trained metasurface, the controlling method comprising:
modeling light propagating from the metasurface;
rendering a virtual image when an image of a virtual space into which the propagated light is projected is captured by the camera module; and
extracting depth information of the rendered virtual image by using a depth extraction network.

12. The controlling method of claim 11, wherein the modeling of light comprises:
for the modeling, applying a coordinate conversion in which the light propagates 180 degrees; and
modeling the form in which the light propagates 360 degrees by performing frontal-rear replication after applying the coordinate conversion.

13. The controlling method of claim 12, wherein for the modeling, the applying of a coordinate conversion in which the light propagates 180 degrees comprises converting planar coordinates into spherical coordinates for the coordinate conversion.

14. The controlling method of claim 11, wherein the rendering of the virtual image comprises:
generating a dataset of the virtual space image-captured by the plurality of fisheye cameras;
calculating position information corresponding to the dataset based on ground truth data; and
rendering pixels of the virtual image based on the position information.

15. The controlling method of claim 14, wherein the rendering of the pixels comprises rendering the pixels by substituting the position information and the dataset into a rendering formula.

16. The controlling method of claim 11, wherein the obtaining of the depth information comprises:
extracting feature points from the virtual image;
finding a matching point of the feature points using a spherical volume production method;
obtaining a cost volume of the virtual image based on the matching point; and
obtaining depth information based on the cost volume.

17. The controlling method of claim 16, wherein the obtaining of depth information based on the cost volume comprises:
converting the cost volume into two-dimensional depth information; and
obtaining the depth information based on edge information of the virtual image and the two-dimensional depth information.

18. The controlling method of claim 11, further comprising:
before the modeling of light propagating from the metasurface, emitting the light;
controlling the polarization angle of the emitted light;
reflecting or transmitting the light based on the polarization angle; and
converting the polarization characteristics of the light from linear polarization to circular polarization and transmitting the circular polarization to the metasurface.

19. The controlling method of claim 11, wherein the metasurface is manufactured by:
replicating a soft mold in reverse;
applying a curable adhesive to the soft mold and pressing the curable adhesive to the substrate; and
curing the curable adhesive pressed to the substrate.

20. The controlling method of claim 11, wherein the rendering of the virtual image when captured by the camera module, comprises:
capturing an image of the virtual space by using an omnidirectional camera or meta lens; and
rendering the virtual image.
